(19) United States
(12) Patent Application Publication
(10) Pub. No.: US 2024/0357509 A1
(43) Pub. Date: Oct. 24, 2024

(54) MAXIMUM POWER CONFIGURATION FOR UPLINK TRANSMIT SWITCHING

(71) Applicant: QUALCOMM Incorporated, San Diego, CA (US)

(72) Inventors: Yiqing CAO, Beijing (CN); Bin HAN, Beijing (CN); Peter GAAL, San Diego, CA (US)

(21) Appl. No.: 18/685,282

(22) PCT Filed: Oct. 29, 2021
(86) PCT No.: PCT/CN2021/127272

§ 371 Date: Feb. 21, 2024

(51) Int. Cl. H04W 52/14; H04W 52/36

(52) U.S. Cl. CPC H04W 52/146; H04W 52/367

(57) ABSTRACT

Wireless communications systems and methods related to communicating control information are provided. A method of wireless communication performed by a user equipment (UE) may include transmitting. to a base station (BS), an indicator indicating a maximum transmit power level associated with a first transmit chain of the UE. receiving. from the BS, an indicator indicating a transmit power level associated with a physical uplink channel and transmitting. to the BS. a communication via the physical uplink channel at a lesser of the maximum transmit power level associated with the first transmit chain of the UE or the indicated transmit power level associated with the physical uplink channel.

This application relates to wireless communication systems, and more particularly, to configuring maximum transmit power configurations for user equipment (UE) operating in uplink transmit (UL TX) switching mode.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mm Wave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. In some aspects, a UE may have multiple transmit chains. Each of the multiple transmit chains may be configured to independently transmit signals. Each of the multiple transmit chains may be configured to simultaneously transmit signals having different waveforms, frame structures, multiplexing schemes, frequencies, and/or power levels. The multiple transmit chains may enable higher reliability and higher bandwidth networking schemes as compared to a UE having a single transmit chain. For example, multiple transmit chains may enable uplink transmit (UL TX) switching. UL TX switching may allow each of the multiple transmit chains to switch the carrier frequency of uplink transmission.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE) may include transmitting, to a base station (BS), an indicator indicating a maximum transmit power level associated with a first transmit chain of the UE; receiving, from the BS, an indicator indicating a transmit power level associated with a physical uplink channel; and transmitting, to the BS, a communication via the physical uplink channel at a lesser of the maximum transmit power level associated with the first transmit chain of the UE or the indicated transmit power level associated with the physical uplink channel.

In an additional aspect of the disclosure, a method of wireless communication performed by a base station (BS) may include receiving, from a user equipment (UE), an indicator indicating a maximum transmit power level associated with a first transmit chain of the UE; transmitting, to the UE, an indicator indicating a transmit power level associated with a physical uplink channel; and receiving, from the UE, a communication via the physical uplink channel at a lesser of the maximum transmit power level associated with the first transmit chain of the UE or the indicated transmit power level associated with the physical uplink channel.

In an additional aspect of the disclosure, a user equipment (UE) may include a memory; a transceiver; and at least one processor coupled to the memory and the transceiver, wherein the UE is configured to transmit, to a base station (BS), an indicator indicating a maximum transmit power level associated with a first transmit chain of the UE; receive, from the BS, an indicator indicating a transmit power level associated with a physical uplink channel; and transmit, to the BS, a communication via the physical uplink channel at a lesser of the maximum transmit power level associated with the first transmit chain of the UE or the indicated transmit power level associated with the physical uplink channel.

In an additional aspect of the disclosure, a base station (BS) may include a memory; a transceiver; and at least one processor coupled to the memory and the transceiver, wherein the BS is configured to receive, from a user equipment (UE), an indicator indicating a maximum transmit power level associated with a first transmit chain of the UE; transmit, to the UE, an indicator indicating a transmit power level associated with a physical uplink channel; and receive, from the UE, a communication via the physical uplink channel at a lesser of the maximum transmit power level associated with the first transmit chain of the UE or the indicated transmit power level associated with the physical uplink channel.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should beunderstood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates various scenarios for UL TX switching according to some aspects of the present disclosure.

FIG. 3 illustrates a wireless communication network according to some aspects of the present disclosure.

FIG. 4 illustrates a frame structure for UL TX switching according to some aspects of the present disclosure.

FIG. 5 is a signaling diagram of a communication method according to some aspects of the present disclosure.

FIG. 6 is a block diagram of an exemplary user equipment (UE) according to some aspects of the present disclosure.

FIG. 7 is a block diagram of an exemplary base station (BS) according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3 GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mm Wave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present application describes mechanisms for configuring a maximum transmit power for a UE operating in UL TX switching mode. In some aspects, a UE may have multiple transmit chains. Each of the multiple transmit chains may be configured to independently transmit signals. Each of the multiple transmit chains may be configured to simultaneously transmit signals having different waveforms, frame structures, multiplexing schemes, frequencies, and/or power levels. Aspects of the present disclosure may provide several benefits. The multiple transmit chains may enable higher reliability and higher bandwidth networking schemes as compared to a UE having a single transmit chain. For example, multiple transmit chains may enable uplink transmit (UL TX) switching. UL TX switching may allow each of the multiple transmit chains to switch the carrier frequency of uplink transmission.

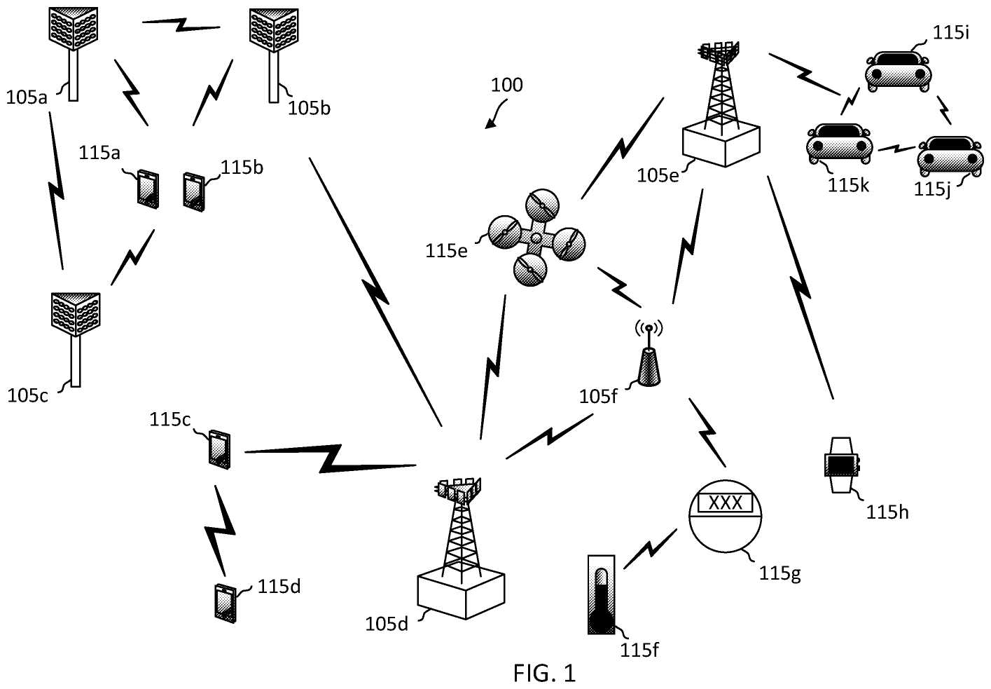

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115l-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g, S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UE 115 may have multiple transmit chains. Each of the multiple transmit chains may be configured to independently transmit signals to the BS 105. Each of the multiple transmit chains may be configured to simultaneously transmit signals having different waveforms, frame structures, multiplexing schemes, frequencies, and/or power levels. Aspects of the present disclosure may provide several benefits. The multiple transmit chains may enable higher reliability and higher bandwidth networking schemes as compared to a UE 115 having a single transmit chain. For example, multiple transmit chains may enable uplink transmit (UL TX) switching. UL TX switching may allow each of the multiple transmit chains to switch the carrier frequency of uplink transmission to the BS 105.

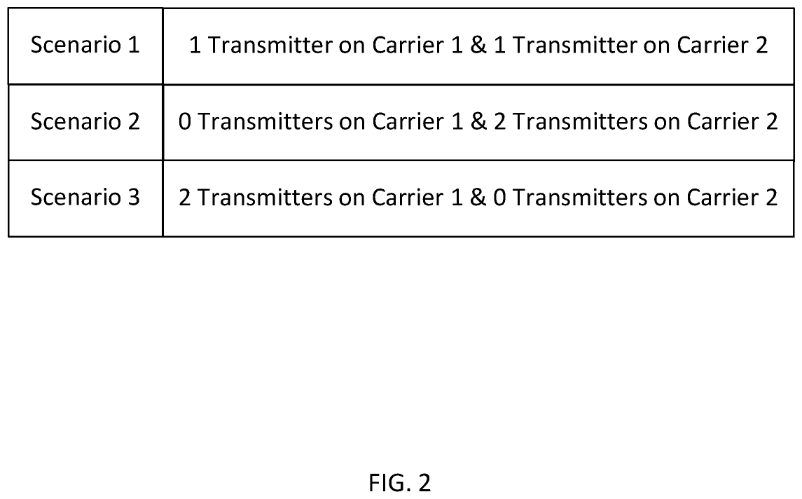

FIG. 2 illustrates various scenarios for UL TX switching according to some aspects of the present disclosure. In some aspects, a UE (e.g., the UE 115 or the UE 600) may have multiple transmit chains. Each of the multiple transmit chains may be configured to independently transmit signals. Each of the multiple transmit chains may be configured to simultaneously transmit signals having different waveforms, frame structures, multiplexing schemes, frequencies, and/or power levels. The multiple transmit chains may enable higher reliability and higher bandwidth networking schemes as compared to a UE having a single transmit chain. For example, multiple transmit chains may enable uplink transmit (UL TX) switching. UL TX switching may allow each of the multiple transmit chains to switch the carrier frequency of uplink transmission. For example, when the UE includes two transmit chains, the first transmit chain and the second transmit chain may be configured to transmit over the same carriers or over different carriers. Further, each of the first and second transmit chains may be configured to switch between carriers on a dynamic basis.

As shown in the table of FIG. 2, in scenario 1, the first transmit chain may transmit on carrier 1 (e.g., a carrier in the 2.1 GHz band or other frequency band) while the second transmit chain may be configured to transmit over carrier 2 (e.g., a carrier in the 3.5 GHz band or other frequency band). The carrier may also be referred to as a component carrier or the like. In scenario 2, both the first and second transmit chains may be configured to transmit over carrier 2 and not to transmit over carrier 1. In scenario 3, both the first and second transmit chains may be configured to transmit over the carrier 1 and not to transmit over carrier 2. When switching between the scenarios, UL TX switching may be activated. In this regard, the UE may receive a message from the BS to switch from one scenario to another scenario. For example, the UE may switch from scenario 1 to scenario 2. The UE may switch from any scenario to any other scenario.

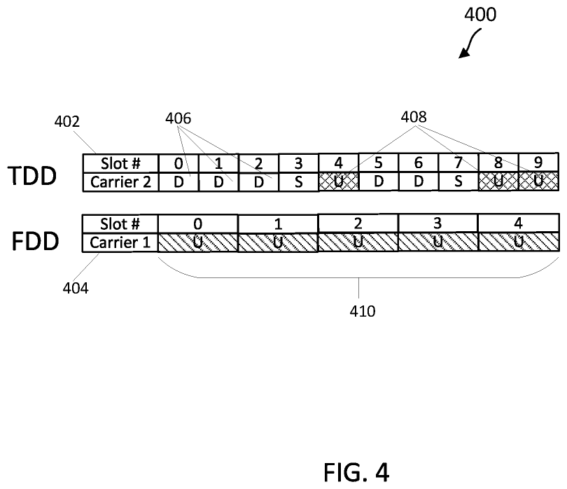

The UE may receive an RRC communication from the BS instructing the UE to switch between the scenarios. As described below with reference to FIG. 4, UL TX switching may be configured for different duplexing modes. For example, the first transmit chain may be configured for time-division duplexing (TDD), while the second transmit chain may be configured for frequency-division duplexing (FDD). In some aspects, UL TX switching may improve the performance of the network when combined with uplink carrier aggregation, supplemental uplink, and/or dual carrier modes as compared to the network operating without UL TX switching.

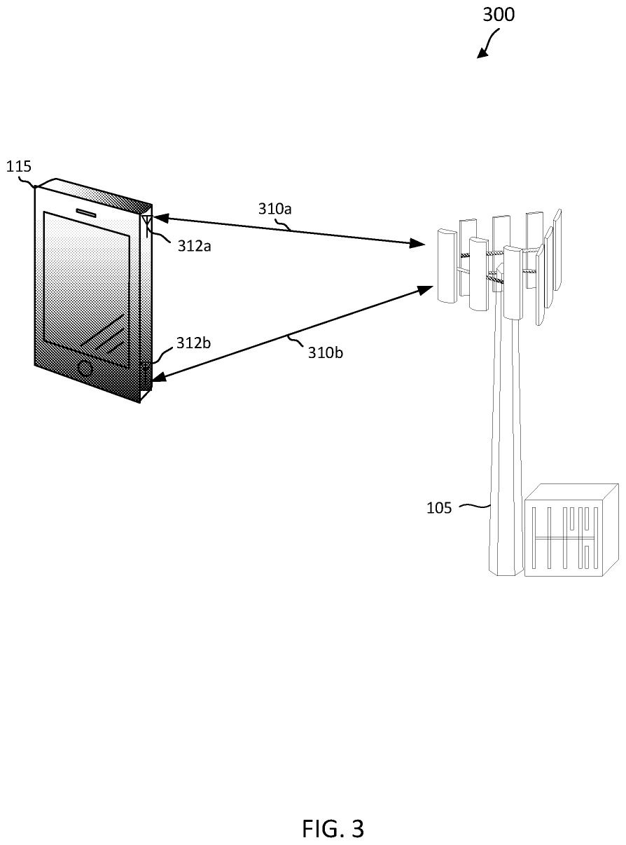

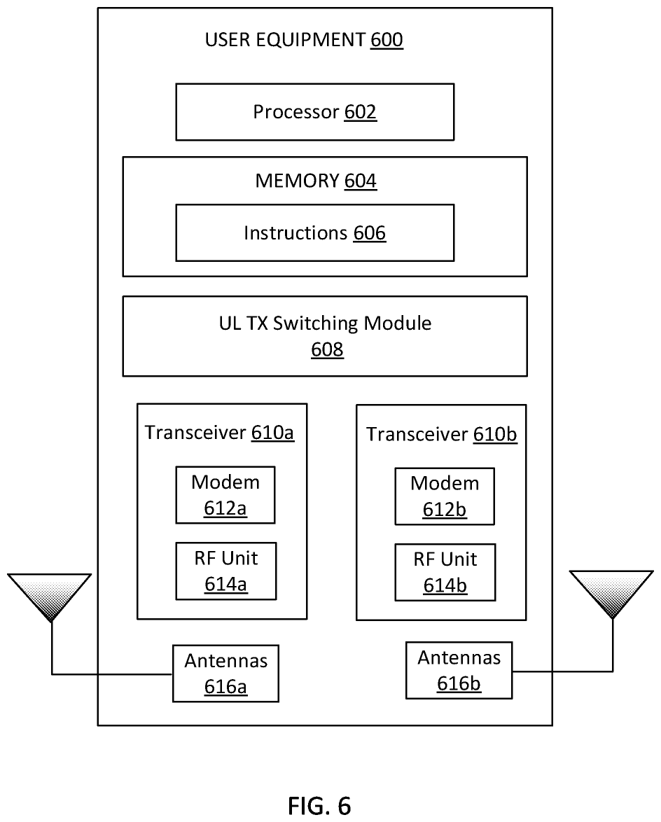

FIG. 3 illustrates a wireless communication network 300 according to some aspects of the present disclosure. The UE 115 of FIG. 3 may include multiple transmit chains. Each of the multiple transmit chains of the UE 115 may include separate and/or shared radio frequency components to enable independent operation and scenario (e.g., carrier) switching. In the example of FIG. 3 showing the UE 115 having two transmit chains 312a and 312b, the first transmit chain 312a may include transceiver 610a and antennas 616a of FIG. 6. The transceiver 610a may include modem 612a and RF unit 614a. The second transmit chain 3 12b may include transceiver 610b and antennas 616b of FIG. 6. The transceiver 610b may include modem 612b and RF unit 614b. Although the first transmit chain 312a and the second transmit chain 312b are presented as having two independent transmit chains configured to transmit simultaneously over separate communication links 310a and 310b respectively to a BS 105, the present disclosure is not so limited as the first transmit chain 312a and the second transmit chain 312b may have two independent receive chains configured to operate simultaneously over communication links 310a and 310b respectively to receive communications from the BS 105. Further, in some instances the first transmit chain 312a and the second transmit chain 312b may share one or multiple components (e.g., transceiver(s), antenna(s), modem(s), and/or RF unit(s)).

In some aspects, the maximum transmit power level associated with the first transmit chain 312a of the UE 115 may be based on the radio circuitry of the first transmit chain 312a (e.g., transceiver 610a, modem 612a, RF unit 614a, and/or antennas 616a). For example, the first transmit chain 312a may have a maximum transmit power level of about 23 dbm, about 20 dbm, or less. In some aspects, the maximum transmit power level may be based on the frequency band in which the UE is to communicate over communication link 310a. In some aspects, the second transmit chain 312b may have the same or different maximum transmit power level. For example, the second transmit chain 312b may have a maximum transmit power level of about 23 dbm, about 20 dbm, or less.

FIG. 4 illustrates operation of a frame structures 400 for data transmissions in UL TX switching mode. In some aspects, the first transmit chain 312a of the UE 115 may be configured for TDD, while the second transmit chain 312b of the UE 115 may be configured for FDD. As illustrated in FIG. 4, frame 402 is provided a first transmit chain 312a on carrier 2 (e.g., a carrier in a high frequency band) and frame 404 is provided on second transmit chain 312b on carrier 1 (e.g., a carrier in a low frequency band). Frame 402 is a TDD frame while frame 404 is an FDD frame. As illustrated in TDD frame 402, the frame structure is “DDDSUDDSUU.” UL slots 408 occur in slot numbers 4, 8, and 9. DL slots 406 are in slot numbers 0-2 and 5-6. FDD frame 404 on carrier 1 illustrates all uplink slots. As illustrated, TDD UL slots 408 in TDD frame 402 are transmitted on first transmit chain 312a on carrier 2 while FDD UL slots 410 are transmitted on second transmit chain 312b on carrier 1.

In some aspects, the transmit power level associated with the physical uplink channel may be associated with a time period (e.g., one or more frame(s), slot(s), sub-slot(s), etc.). For example, the transmit power level associated with the uplink slots 4, 8, and 9 in frame 402 may change or remain the same for each of the uplink slots 4, 8, and 9.

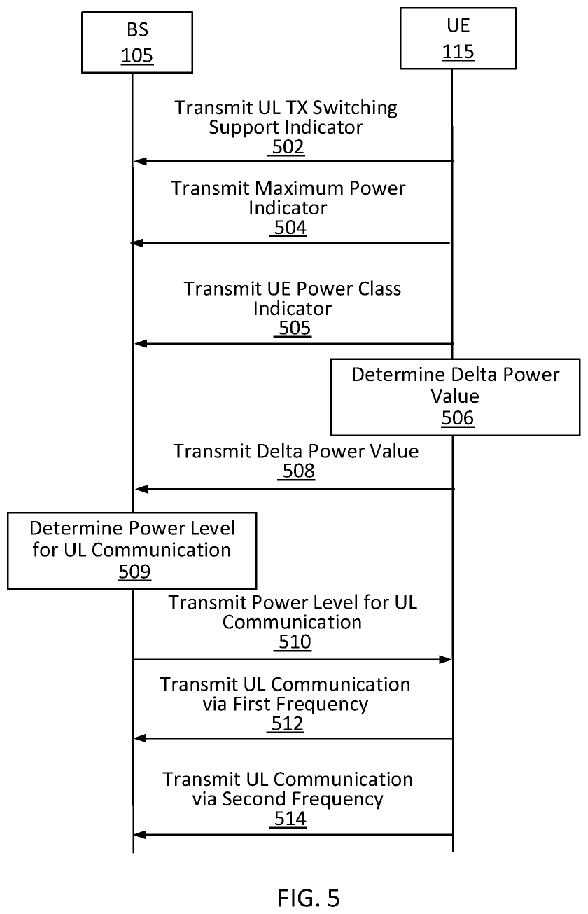

FIG. 5 is a signaling diagram of a communication method according to some aspects of the present disclosure. Steps of the signaling diagram 500 can be executed by a computing device (e.g., a processor, processing circuit, and/or other suitable component) of a communication device or other suitable means for performing the steps. For example, a wireless communication device, such as the UE 115 or UE 600, may utilize one or more components, such as the processor 602, the memory 604, the UL TX switching module 608, the transceivers 610a and 610b, the modems 612a and 612b, and the one or more antennas 616a and 616b, to execute the aspects of signaling diagram 500. For example, a wireless communication device, such as the BS 105 or BS 700, may utilize one or more components, such as the processor 702, the memory 704, the UL TX switching module 708, the transceiver 710, the modem 712, and the one or more antennas 716, to execute the aspects of signaling diagram 500.

At action 502, the UE 115 may transmit an UL TX switching support indicator to the BS 105. In this regard, the UE may transmit the indicator indicating UL TX switching support via a radio resource control (RRC) communication. For example, the UE may transmit the indicator in an RRC information element (e.g., uplink Tx Switching-Option Support-r16). The UL TX switching support indicator may indicate which option is supported for dynamic UL Tx switching.

At action 504, the UE 115 may transmit a maximum power indicator to the BS 105. In this regard, the UE may transmit the indicator indicating the maximum transmit power level associated with the first transmit chain of the UE via a radio resource control (RRC) communication. In some aspects, the maximum power indicator may be a maximum power indicator (e.g., ue-PowerClass) associated with a UE power class. The ue-PowerClass may specify the maximum power the UE can reach. For example, UE may achieve the maximum power by aggregating 2 separate UL TX (e.g., UL Full Power Mode). The UE may transmit the indicator in an RRC information element. In some aspects, the UE 115 may have multiple transmit chains. Each of the multiple transmit chains may be configured to independently transmit signals. Each of the multiple transmit chains may be configured to simultaneously transmit signals having different waveforms, frame structures, multiplexing schemes, frequencies, and/or power levels. The multiple transmit chains may enable higher reliability and higher bandwidth networking schemes as compared to a UE 115 having a single transmit chain. For example, multiple transmit chains may enable uplink transmit (UL TX) switching. UL TX switching may allow each of the multiple transmit chains to switch the carrier frequency of uplink transmission. For example, when the UE 115 includes two transmit chains, the first transmit chain and the second transmit chain may be configured to transmit over the same carriers or over different carriers. Further, each of the first and second transmit chains may be configured to switch between carriers on a dynamic basis. For example, in a first scenario, the first transmit chain may transmit on a first carrier (e.g., a carrier in the 2.1 GHz band or other frequency band) while the second transmit chain may be configured to transmit over a different carrier (e.g., a carrier in the 3.5 GHz band or other frequency band). In a second scenario, both the first and second transmit chains may be configured to transmit over the first carrier. In a third scenario, both the first and second transmit chains may be configured to transmit over the second carrier. When switching between the scenarios, UL TX switching may be activated. In this regard, the UE 115 may receive a message from the BS 105 to switch from one scenario to another scenario. The UE 115 may receive an RRC communication from the BS 105 instructing the UE 115 to switch between the scenarios

At action 505, the UE 115 may transmit a UE power class message as the indicator indicating the maximum transmit power level associated with the first transmit chain of the UE 115. In this regard, the UE 115 may transmit a ue-PowerClass-ULTx-PCMode1 message to the BS 105. The UE 115 may transmit the ue-PowerClass-ULTx-PCMode1 message or other power class indicating message to the BS 105 in an RRC communication. For example, the UE 115 may include a power class indication in an RRC information element. In some aspects, transmitting the power class message as the indicator indicating the maximum transmit power level associated with the first transmit chain of the UE 115 may be based on the UE supporting UL TX switching as indicated in action 502. The ue-PowerClass-ULTx-PCMode1 message may be used by the BS 105 at action 506 to limit the transmit power level associated with a physical uplink channel to the maximum capability of the UE's transmit chain.

At action 506, additionally or alternatively (e.g., alternatively to action 505), the UE may determine a delta power value. In some aspects, the delta power value may be a default value. For example, the delta power value may be about 1.5 dbm, about 3 dbm, about 4.5 dbm, about 6 dbm, or other suitable value. In some aspects, the delta power value may be based on the number of transmit chains in the UE 115. For example, if the UE 115 has two transmit chains, the delta power value may be about 3 dbm. As another example, if the UE 115 has four transmit chains, the delta power value may be about 6 dbm.

At action 508, the UE 115 may transmit the delta power value to the BS 105. The UE 115 may transmit the delta power value to the BS 105 via an RRC communication (e.g., an RRC information element) or other suitable communication. For example, the RRC information element may be defined as power-delta-ULTX-FPmode1 or the like.

At action 509, the BS 105 may determine the power level associated with the physical uplink channel. The BS may determine the power level associated with the physical uplink channel based on the power class message received at action 505 indicating the maximum transmit power level associated with the first transmit chain of the UE 115 (e.g., ue-PowerClass-UL.Tx-PCMode1). Additionally or alternatively, the BS 105 may determine the power level associated with the physical uplink channel based on the delta power value received from the UE at action 508. For example, when the first and second transmit chains are configured to transmit over different carriers, the

BS 105 may configure each transmit chain for a transmit power level limited to the maximum power indicator (e.g., ue-PowerClass) minus the delta power value. Achieving the maximum power may require aggregating the two transmit chains for a power level of 26 dbm. However, if each of the transmit chains is limited to 23 dbm and operating over a different carrier, the BS 105 may reduce the transmit power level associated with the physical uplink channel by the delta power value.

At action 510, the BS 105 may transmit a power level for uplink communication to the UE 115. The BS 105 may transmit the transmit power level to the UE 115 in an uplink power control message via an RRC communication (e.g., an RRC information element). The BS 105 may transmit an indicator to the UE 115 indicating a transmit power level associated with a physical uplink channel (e.g., a physical uplink shared channel (PUSCH), a physical uplink control channel (PUCCH), and/or a physical random access channel (PRACH)). In this regard, the BS 105 may transmit the indicator (e.g., an uplink power control message) to the UE 115 via an RRC communication (e.g., an RRC information element) or other suitable communication. The transmit power level associated with the physical uplink channel transmitted to the UE 115 may be based on the UE 115 supporting UL TX switching. For example, when the UE 115 supports UL TX switching and is configured to operate in a UL TX switching scenario in which the first transmit chain transmits on a first carrier while the second transmit chain transmits over a different second carrier, the transmit power level associated with the physical uplink channel may be set by the BS 105 not to exceed the maximum capability of the UE's transmit chain(s). In some aspects, when the UE 115 is configured for transmitting on the first and second transmit chains using the same carrier, the BS 105 may configure the UE 115 to transmit in a full power mode (e.g., ul-FullPwrMode 1-r16) in which the two transmit chains are aggregated. For example, the first and second transmit chains may each transmit at 23 dbm for an aggregated power level of 26 dbm. However, when the first and second transmit chains are configured to transmit over different carriers, the BS 105 may configure each transmit chain for a transmit power level limited to the maximum power indicated in the power class message (e.g., ue-PowerClass-ULTx-PCMode 1).

At action 512, the UE may transmit a first UL communication to the BS 105 in a first frequency. In this regard, the UE 115 may transmit the first UL communication via a PUSCH, a PUCCH, or a PRACH. The UE 115 may receive a configuration from the BS 105 to transmit the communication at a power level limited to the power class of the UE (e.g., ue-PowerClass-ULTx-PCMode 1) based on the UE 115 operating in UL TX switching mode.

At action 514, the UE may transmit a second UL communication to the BS 105 in a second frequency. In some aspects the UE 115 may transmit the second communication to the BS 105 via a second transmit chain of the UE 115 in a second frequency range at a maximum transmit power level associated with the second transmit chain. The second frequency range may be different from the first frequency range. For example, the first frequency range may be a carrier in the 2.1 GHz band while the second frequency range may be a carrier in the 3.5 GHz band. However, any combination of frequency ranges may be used across the different transmit chains of the UE 115. The UE 115 may simultaneously transmit the first and second communications to the BS 105 in order to increase the bandwidth (e.g., the data rate) of the communication link between the UE 115 and the BS 105 as compared to sequentially transmitting the first and second communications over a single frequency and a single transmit chain.

FIG. 6 is a block diagram of an exemplary UE 600 according to some aspects of the present disclosure. The UE 600 may be the UE 115 in the network 100, 200, or 300 as discussed above. As shown, the UE 600 may include a processor 602, a memory 604, a UL TX switching module 608, transceivers 610a and 610b including modem subsystems 612a and 612b and radio frequency (RF) units 614a and 614b, and one or more antennas 616a and 616b respectively. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 2-5 and 8-9. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The UL TX switching module 608 may be implemented via hardware, software, or combinations thereof. For example, the UL TX switching module 608 may be implemented as a processor, circuit, and/or instructions 606 stored in the memory 604 and executed by the processor 602.

In some aspects, the UL TX switching module 608 is configured to control multiple transmit chains of the UE. Each of the multiple transmit chains may be configured to independently transmit signals. Each of the multiple transmit chains may be configured to simultaneously transmit signals having different waveforms, frame structures, multiplexing schemes, frequencies, and/or power levels. The multiple transmit chains may enable higher reliability and higher bandwidth networking schemes as compared to a UE having a single transmit chain. For example, multiple transmit chains may enable uplink transmit (UL TX) switching. UL TX switching may allow each of the multiple transmit chains to switch the carrier frequency of uplink transmission.

As shown, the transceivers 610a and 610b may include the modem subsystems 612a, 612b and the RF units 614a and 614b. The transceivers 610a and 610b can be configured to communicate bi-directionally with other devices, such as the BSs 105 and/or the UEs 115 over multiple carrier frequencies. The modem subsystems 612a and 612b may be configured to modulate and/or encode the data from the memory 604 and the UL TX switching module 608 according to a modulation and coding scheme (MCS), e.g., a low-density parity check (LDPC) coding scheme, a turbo coding scheme, a convolutional coding scheme, a digital beamforming scheme, etc. The RF units 614a and 614b may be configured to process (e.g., perform analog to digital conversion or digital to analog conversion, etc.) modulated/encoded data from the modem subsystems 612a and 612b (on outbound transmissions) or of transmissions originating from another source such as a UE 115 or a BS 105. The RF units 614a and 614b may be further configured to perform analog beamforming in conjunction with the digital beamforming. Although shown as integrated together in transceivers 610a and 610b, the modem subsystems 612a and 612b and the RF units 614a and 614b may be separate devices that are coupled together to enable the UE 600 to communicate with other devices.

The RF units 614a and 614b may provide the modulated and/or processed data, e.g. data packets (or, more generally, data messages that may contain one or more data packets and other information), to the antennas 616a and 616b for transmission to one or more other devices. The antennas 616a and 616b may further receive data messages transmitted from other devices. The antennas 616a and 161b may provide the received data messages for processing and/or demodulation at the transceivers 610a and 610b. The antennas 616a and 616b may include multiple antennas of similar or different designs in order to sustain multiple transmission links. The RF units 614a and 614b may configure the antennas 616a and 616b.

In some instances, the UE 600 can include multiple transceivers 610a and 610b implementing different RATs (e.g., NR and LTE). In some instances, the UE 600 can include a single transceiver 610 implementing multiple RATs (e.g., NR and LTE). In some instances, the transceivers 610a and 610b can include various components, where different combinations of components can implement RATs.

In some aspects, the processor 602 may be coupled to the memory 604, the UL TX switching module 608, and/or the transceivers 610a and 610b. The processor 602 and may execute operating system (OS) code stored in the memory 604 in order to control and/or coordinate operations of the UL TX switching module 608 and/or the transceivers 610a and 610b. In some aspects, the processor 602 may be implemented as part of the UL TX switching module 608.

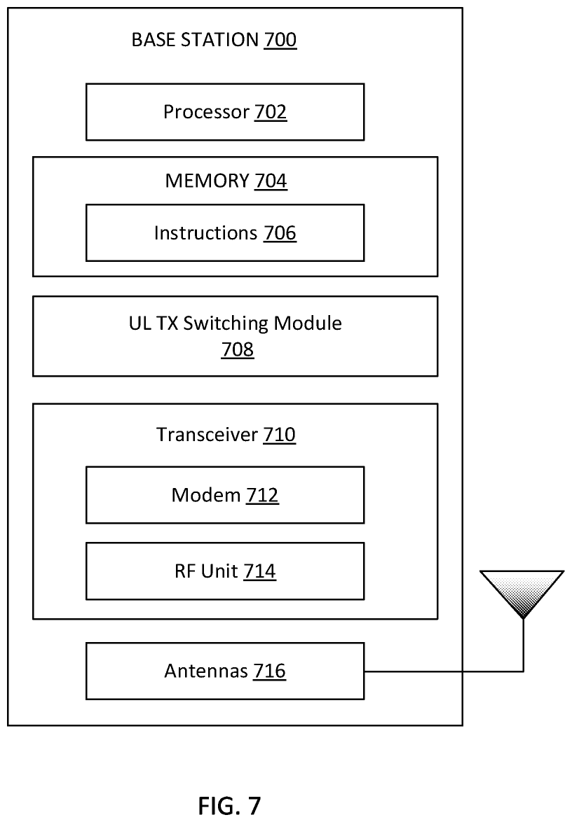

FIG. 7 is a block diagram of an exemplary BS 700 according to some aspects of the present disclosure. The BS 700 may be a BS 105 as discussed above. As shown, the BS 700 may include a processor 702, a memory 704, a UL TX switching module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 2-5 and 8-9. Instructions 706 may also be referred to as code, which may be interpreted broadly to include any type of computer-readable statement(s).

The UL TX switching module 708 may be implemented via hardware, software, or combinations thereof. For example, the UL TX switching module 708 may be implemented as a processor, circuit, and/or instructions 706 stored in the memory 704 and executed by the processor 702.

The UL TX switching module 708 may be used for various aspects of the present disclosure, for example, aspects of FIGS. 2-5 and 8-9.

Additionally or alternatively, the UL TX switching module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem sub system 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the BS 700 to enable the BS 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a plurality of sub-slots within a slot according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the BS 700 can include multiple transceivers 710 implementing different RATs (e.g., NR and LTE). In some instances, the BS 700 can include a single transceiver 710 implementing multiple RATs (e.g., NR and LTE). In some instances, the transceiver 710 can include various components, where different combinations of components can implement RATs.

In some aspects, the processor 702 may be coupled to the memory 704, the UL TX switching module 708, and/or the transceiver 710. The processor 702 may execute OS code stored in the memory 704 to control and/or coordinate operations of the UL TX switching module 708, and/or the transceiver 710. In some aspects, the processor 702 may be implemented as part of the UL TX switching module 708. In some aspects, the processor 702 is configured to transmit via the transceiver 710, to a UE, an indicator indicating a configuration of sub-slots within a slot.

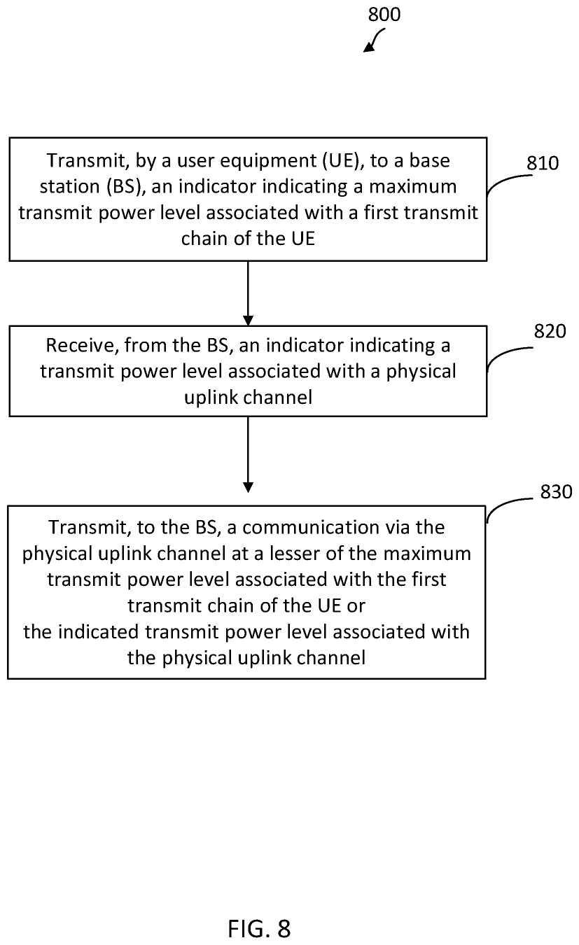

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the actions. For example, a wireless communication device, such as the UE 115 or UE 600, may utilize one or more components, such as the processor 602, the memory 604, the UL TX switching module 608, the transceivers 610a and 610b, the modems 612a and 612b, and the one or more antennas 616a and 616b, to execute aspects of method 800. The method 800 may employ similar mechanisms as in the networks 100, 200, or 300 and the aspects and actions described with respect to FIGS. 2-5. As illustrated, the method 800 includes a number of enumerated actions, but the method 800 may include additional actions before, after, and in between the enumerated actions. In some aspects, one or more of the enumerated actions may be omitted or performed in a different order.

At action 810, the method 800 includes a UE (e.g., the UE 115 or the UE 600) transmitting an indicator indicating a maximum transmit power level associated with a first transmit chain of the UE to a base station (BS). In this regard, the UE may transmit the indicator indicating the maximum transmit power level associated with the first transmit chain of the UE via a radio resource control (RRC) communication. For example, the UE may transmit the indicator in an RRC information element. In some aspects, the UE may have multiple transmit chains. Each of the multiple transmit chains may be configured to independently transmit signals. Each of the multiple transmit chains may be configured to simultaneously transmit signals having different waveforms, frame structures, multiplexing schemes, frequencies, and/or power levels. The multiple transmit chains may enable higher reliability and higher bandwidth networking schemes as compared to a UE having a single transmit chain. For example, multiple transmit chains may enable uplink transmit (UL TX) switching. UL TX switching may allow each of the multiple transmit chains to switch the carrier frequency of uplink transmission. For example, when the UE includes two transmit chains, the first transmit chain and the second transmit chain may be configured to transmit over the same carriers or over different carriers. Further, each of the first and second transmit chains may be configured to switch between carriers on a dynamic basis. For example, in a first scenario, the first transmit chain may transmit on a first carrier (e.g., a carrier in the 2.1 GHz band or other frequency band) while the second transmit chain may be configured to transmit over a different carrier (e.g., a carrier in the 3.5 GHz band or other frequency band). In a second scenario, both the first and second transmit chains may be configured to transmit over the first carrier. In a third scenario, both the first and second transmit chains may be configured to transmit over the second carrier. When switching between the scenarios, UL TX switching may be activated. In this regard, the UE may receive a message from the BS to switch from one scenario to another scenario. The UE may receive an RRC communication from the BS instructing the UE to switch between the scenarios. Further, UL TX switching may be configured for different duplexing modes. For example, the first transmit chain may be configured for time-division duplexing (TDD), while the second transmit chain may be configured for frequency-division duplexing (FDD). In some aspects, UL TX switching may improve the performance of the network when combined with uplink carrier aggregation, supplemental uplink, and/or dual carrier modes as compared to the network operating without UL TX switching.

Each of the multiple transmit chains of the UE may include separate and/or shared radio frequency components to enable independent operation and scenario (e.g., carrier) switching. In the example of the UE having two transmit chains, the first transmit chain may include transceiver 610a and antennas 616a of FIG. 6. The transceiver 610a may include modem 612a and RF unit 614a. The second transmit chain may include transceiver 610b and antennas 616b of FIG. 6. The transceiver 610b may include modem 612b and RF unit 614b. Although the first and second transmit chains are presented as having two independent transmit chains configured to operate simultaneously over separate carriers, the present disclosure is not so limited as the first and second transmit chains may have two independent receive chains configured to operate simultaneously over separate carriers to receive communications. Further, in some instances the first and second transmit chains may share one or multiple components (e.g., transceiver(s), antenna(s), modem(s), and/or RF unit(s)).

In some aspects, the maximum transmit power level associated with the first transmit chain of the UE may be based on the radio circuitry of the first transmit chain (e.g., transceiver 610a, modem 612a, RF unit 614a, and/or antennas 616a). For example, the first transmit chain may have a maximum transmit power level of about 23 dbm, about 20 dbm, or less. In some aspects, the maximum transmit power level may be based on the frequency band in which the UE is to communicate. In some aspects, the second transmit chain may have the same or different maximum transmit power level. For example, the second transmit chain may have a maximum transmit power level of about 23 dbm, about 20 dbm, or less.

In some aspects, the UE may transmit a UE power class message as the indicator indicating the maximum transmit power level associated with the first transmit chain of the UE. In this regard, the UE may transmit a ue-PowerClass-UL.Tx-PCMode 1 message to the BS. The UE may transmit the ue-PowerClass-ULTx-PCMode 1 message or other power class indicating message to the BS in an RRC communication. For example, the UE may include a power class indication in an RRC information element. In some aspects, transmitting the power class message as the indicator indicating the maximum transmit power level associated with the first transmit chain of the UE may be based on the UE supporting UL TX switching. The ue-PowerClass-ULTx-PCMode1 message may be used by the BS to limit the transmit power level associated with a physical uplink channel to the maximum capability of the UE's transmit chain.

At action 820, the method 800 includes the UE receiving an indicator from the BS indicating a transmit power level associated with a physical uplink channel (e.g., a physical uplink shared channel (PUSCH), a physical uplink control channel (PUCCH), and/or a physical random access channel (PRACH)). In this regard, the UE may receive the indicator (e.g., an uplink power control message) from the BS via an RRC communication (e.g., an RRC information element) or other suitable communication. The transmit power level associated with the physical uplink channel received from the BS may be based on the UE supporting UL TX switching. For example, when the UE supports UL TX switching and is configured to operate in a UL TX switching scenario in which the first transmit chain transmits on a first carrier while the second transmit chain transmits over a different second carrier, the transmit power level associated with the physical uplink channel may be set by the BS not to exceed the maximum capability of the UEs transmit chain(s). In some aspects, when the UE is configured for transmitting on the first and second transmit chains using the same carrier, the BS may configure the UE to transmit in a full power mode (e.g., ul-FullPwrMode 1-r16) in which the two transmit chains are aggregated. For example, the first and second transmit chains may each transmit at 23 dbm for an aggregated power level of 26 dbm.

However, when the first and second transmit chains are configured to transmit over different carriers, the BS may configure each transmit chain for a transmit power level limited to the maximum power indicated in the power class message (e.g., ue-PowerClass-ULTx-PCMode 1).

At action 830, the method 800 includes the UE transmitting a communication via the physical uplink channel to the BS at a lesser of the maximum transmit power level associated with the first transmit chain of the UE or the indicated transmit power level associated with the physical uplink channel. In this regard, the UE may transmit the communication via a PUSCH, a PUCCH, or a PRACH. As described above at action 820, the UE may receive a configuration from the BS to transmit the communication at a power level limited to the power class of the UE (e.g., ue-PowerClass-ULTx-PCMode 1) based on the UE operating in UL TX switching mode.

In some aspects, the maximum transmit power level associated with the first transmit chain may be indicated by a delta power value. The UE may transmit the delta power value to the BS via an RRC communication (e.g., an RRC information element) or other suitable communication. The BS may determine the power level associated with the physical uplink channel based on the delta power value. For example, when the first and second transmit chains are configured to transmit over different carriers, the BS may configure each transmit chain for a transmit power level limited to UL full power mode 1 (e.g., ul-FullPwrMode 1-r16) minus the delta power value. UL full power mode 1 may require aggregating the two transmit chains for a power level of 26 dbm. However, if each of the transmit chains is limited to 23 dbm and operating over a different carrier, the BS may reduce the transmit power level associated with the physical uplink channel by the delta value. The BS may transmit the reduced transmit power level to the UE in an uplink power control message via an RRC communication (e.g., an RRC information element).

In some aspects, the delta power value may be a default value (e.g., power-delta-ULTX-FPmode 1). For example, the delta power value may be about 1.5 dbm, about 3 dbm, about 4.5 dbm, about 6 dbm, or other suitable value. In some aspects, the delta power value may be based on the number of transmit chains in the UE. For example, if the UE has two transmit chains, the delta power value may be about 3 dbm. As another example, if the UE has four transmit chains, the delta power value may be about 6 dbm.

In some aspects, the UE may transmit the communication in a first frequency range at the maximum transmit power level associated with the first transmit chain and transmit a second communication to the BS via a second transmit chain of the UE in a second frequency range at a maximum transmit power level associated with the second transmit chain. The second frequency range may be different from the first frequency range. For example, the first frequency range may be a carrier in the 2.1 GHz band while the second frequency range may be a carrier in the 3.5 GHz band. However, any combination of frequency ranges may be used across the different transmit chains of the UE. The UE may simultaneously transmit the first and second communications to the BS in order to increase the bandwidth (e.g., the data rate) of the communication link between the UE and the BS as compared to sequentially transmitting the first and second communications over a single frequency and a single transmit chain.

In some aspects, the transmit power level associated with the physical uplink channel may be associated with a time period (e.g., one or more frame(s), slot(s), sub-slot(s), etc.). For example, the transmit power level associated with the uplink may change for each transmit occasion or group of transmit occasions. In some instances, the transmit occasion may be a slot or a number of slots.

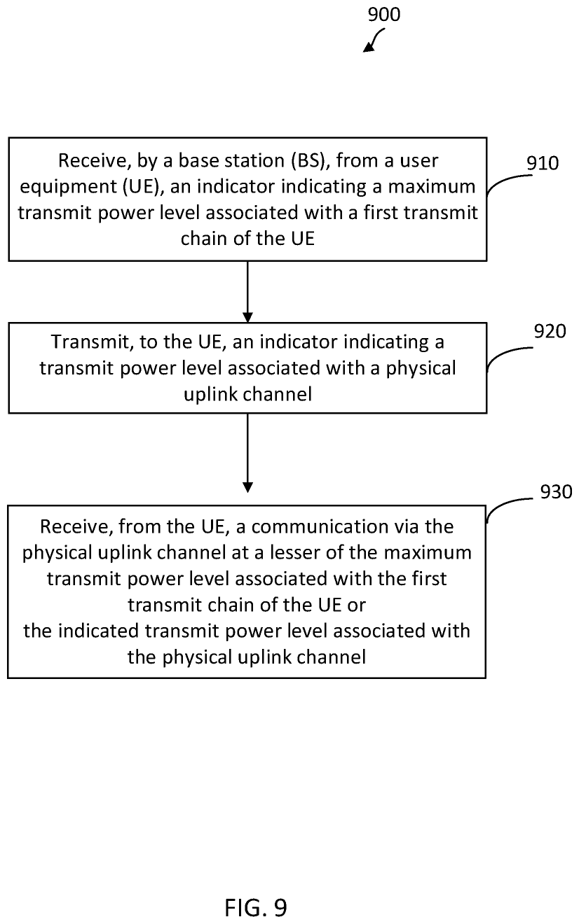

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the actions. For example, a wireless communication device, such as the BS 105 or BS 700, may utilize one or more components, such as the processor 702, the memory 704, the UL TX switching module 708, the transceiver 710, the modem 712, and the one or more antennas 716, to execute aspects of method 900. The method 900 may employ similar mechanisms as in the networks 100, 200, or 300 and the aspects and actions described with respect to FIGS. 2-5. As illustrated, the method 900 includes a number of enumerated actions, but the method 900 may include additional actions before, after, and in between the enumerated actions. In some aspects, one or more of the enumerated actions may be omitted or performed in a different order.

At action 910, the method 900 includes a BS (e.g., the BS 105 or the BS 700) receiving from a UE (e.g., the UE 115 or the UE 600), an indicator indicating a maximum transmit power level associated with a first transmit chain of the UE. In this regard, the BS may receive the indicator indicating the maximum transmit power level associated with the first transmit chain of the UE via a radio resource control (RRC) communication. For example, the BS may receive the indicator in an RRC information element. In some aspects, the UE may have multiple transmit chains. Each of the multiple transmit chains may be configured to independently transmit signals. Each of the multiple transmit chains may be configured to simultaneously transmit signals having different waveforms, frame structures, multiplexing schemes, frequencies, and/or power levels. The multiple transmit chains may enable higher reliability and higher bandwidth networking schemes as compared to a UE having a single transmit chain. For example, multiple transmit chains may enable uplink transmit (UL TX) switching. UL TX switching may allow each of the multiple transmit chains to switch the carrier frequency of uplink transmission. For example, when the UE includes two transmit chains, the first transmit chain and the second transmit chain may be configured to transmit over the same carriers or over different carriers. Further, each of the first and second transmit chains may be configured to switch between carriers on a dynamic basis. For example, in a first scenario, the first transmit chain may transmit on a first carrier (e.g., a carrier in the 2.1 GHz band or other frequency band) while the second transmit chain may be configured to transmit over a different carrier (e.g., a carrier in the 3.5 GHz band or other frequency band). In a second scenario, both the first and second transmit chains may be configured to transmit over the first carrier. In a third scenario, both the first and second transmit chains may be configured to transmit over the second carrier. When switching between the scenarios, UL TX switching may be activated. In this regard, the BS may transmit a message to the UE to switch from one scenario to another scenario. The BS may transmit an RRC communication to the UE instructing the UE to switch between the scenarios. Further, UL TX switching may be configured for different duplexing modes. For example, the first transmit chain may be configured for time-division duplexing (TDD), while the second transmit chain may be configured for frequency-division duplexing (FDD). In some aspects, UL TX switching may improve the performance of the network when combined with uplink carrier aggregation, supplemental uplink, and/or dual carrier modes as compared to the network operating without UL TX switching.

Each of the multiple transmit chains of the UE may include separate and/or shared radio frequency components to enable independent operation and scenario (e.g., carrier) switching. In the example of the UE having two transmit chains, the first transmit chain may include transceiver 610a and antennas 616a of FIG. 6. The transceiver 610a may include modem 612a and RF unit 614a. The second transmit chain may include transceiver 610b and antennas 616b of FIG. 6. The transceiver 610b may include modem 612b and RF unit 614b. Although the first and second transmit chains are presented as having two independent transmit chains configured to operate simultaneously over separate carriers, the present disclosure is not so limited as the first and second transmit chains may have two independent receive chains configured to operate simultaneously over separate carriers to receive communications. Further, in some instances the first and second transmit chains may share one or multiple components (e.g., transceiver(s), antenna(s), modem(s), and/or RF unit(s)).

In some aspects, the maximum transmit power level associated with the first transmit chain of the UE may be based on the radio circuitry of the first transmit chain (e.g., transceiver 610a, modem 612a, RF unit 614a, and/or antennas 616a). For example, the first transmit chain may have a maximum transmit power level of about 23 dbm, about 20 dbm, or less. In some aspects, the maximum transmit power level may be based on the frequency band in which the UE is to communicate. In some aspects, the second transmit chain may have the same or different maximum transmit power level. For example, the second transmit chain may have a maximum transmit power level of about 23 dbm, about 20 dbm, or less.

In some aspects, the BS may receive a UE power class message from the UE as the indicator indicating the maximum transmit power level associated with the first transmit chain of the UE. In this regard, the BS may receive a ue-PowerClass-ULTx-PCMode1 message from the UE. The BS may receive the ue-PowerClass-ULTx-PCMode1 message or other power class indicating message from the UE in an RRC communication. For example, the BS may receive a power class indication of the UE in an RRC information element. In some aspects, the BS receiving the power class message as the indicator indicating the maximum transmit power level associated with the first transmit chain of the UE may be based on the UE supporting UL TX switching. The ue-PowerClass-ULTx-PCMode1 message may be used by the BS to limit the transmit power level associated with a physical uplink channel to the maximum capability of the UE's transmit chain.

At action 920, the method 900 includes the BS transmitting an indicator to the UE indicating a transmit power level associated with a physical uplink channel (e.g., a physical uplink shared channel (PUSCH), a physical uplink control channel (PUCCH), and/or a physical random access channel (PRACH)). In this regard, the BS may transmit the indicator (e.g., an uplink power control message) to the UE via an RRC communication (e.g., an RRC information element) or other suitable communication. The transmit power level associated with the physical uplink channel transmitted to the UE may be based on the UE supporting UL TX switching. For example, when the UE supports UL TX switching and is configured to operate in a UL TX switching scenario in which the first transmit chain transmits on a first carrier while the second transmit chain transmits over a different second carrier, the transmit power level associated with the physical uplink channel may be set by the BS not to exceed the maximum capability of the UEs transmit chain(s). In some aspects, when the UE is configured for transmitting on the first and second transmit chains using the same carrier, the BS may configure the UE to transmit in a full power mode (e.g., ul-FullPwrMode 1-r16) in which the two transmit chains are aggregated. For example, the first and second transmit chains may each transmit at 23 dbm for an aggregated power level of 26 dbm. However, when the first and second transmit chains are configured to transmit over different carriers, the BS may configure each transmit chain for a transmit power level limited to the maximum power indicated in the power class message (e.g., ue-PowerClass-ULTx-PCMode 1).

At action 930, the method 900 includes the BS receiving a communication via the physical uplink channel from the UE at a lesser of the maximum transmit power level associated with the first transmit chain of the UE or the indicated transmit power level associated with the physical uplink channel. In this regard, the BS may receive the communication via a PUSCH, a PUCCH, or a PRACH. As described above at action 920, the BS may transmit a configuration to the UE to transmit the communication at a power level limited to the power class of the UE (e.g., ue-PowerClass-ULTx-PCMode1) based on the UE operating in UL TX switching mode.

In some aspects, the maximum transmit power level associated with the first transmit chain may be indicated by a delta power value. The BS may receive the delta power value from the UE via an RRC communication (e.g., power-delta-ULTX-FPmode1) or other suitable communication. The BS may determine the power level associated with the physical uplink channel based on the delta power value. For example, when the first and second transmit chains are configured to transmit over different carriers, the BS may configure each transmit chain for a transmit power level limited to UL full power mode 1 (e.g., ul-FullPwrMode 1-r16) minus the delta power value. UL full power mode 1 may require aggregating the two transmit chains for a power level of 26 dbm. However, if each of the transmit chains is limited to 23 dbm and operating over a different carrier, the BS may reduce the transmit power level associated with the physical uplink channel by the delta value. The BS may transmit the reduced transmit power level to the UE in an uplink power control message via an RRC communication (e.g., an RRC information element).

In some aspects, the delta power value may be a default value. For example, the delta power value may be about 1.5 dbm, about 3 dbm, about 4.5 dbm, about 6 dbm, or other suitable value. In some aspects, the delta power value may be based on the number of transmit chains in the UE. For example, if the UE has two transmit chains, the delta power value may be about 3 dbm. As another example, if the UE has four transmit chains, the delta power value may be about 6 dbm.

In some aspects, the BS may receive the communication in a first frequency range at the maximum transmit power level associated with the first transmit chain and receive a second communication from the UE via a second transmit chain of the UE in a second frequency range at a maximum transmit power level associated with the second transmit chain. The second frequency range may be different from the first frequency range. For example, the first frequency range may be a carrier in the 2.1 GHz band while the second frequency range may be a carrier in the 3.5 GHz band. However, any combination of frequency ranges may be used across the different transmit chains of the UE. The BS may simultaneously receive the first and second communications from the UE in order to increase the bandwidth (e.g., the data rate) of the communication link between the UE and the BS as compared to sequentially receiving the first and second communications over a single frequency and a single transmit chain.

In some aspects, the transmit power level associated with the physical uplink channel may be associated with a time period (e.g., one or more frame(s), slot(s), sub-slot(s), etc.). For example, the transmit power level associated with the uplink may change for each transmit occasion or group of transmit occasions. In some instances, the transmit occasion may be a slot or a number of slots.

Further aspects of the present disclosure include the following:

Aspect 1 includes a method of wireless communication performed by a user equipment (UE), the method comprising transmitting, to a base station (BS), an indicator indicating a maximum transmit power level associated with a first transmit chain of the UE; receiving, from the BS, an indicator indicating a transmit power level associated with a physical uplink channel; and transmitting, to the BS, a communication via the physical uplink channel at a lesser of the maximum transmit power level associated with the first transmit chain of the UE or the indicated transmit power level associated with the physical uplink channel.

Aspect 2 includes the method of aspect 1, further comprising transmitting, to the BS, an indicator indicating the UE supports uplink transmit (UL TX) switching; and wherein the transmitting the indicator indicating the maximum transmit power level associated with the first transmit chain of the UE comprises transmitting the indicator based on the UE support for UL TX switching.

Aspect 3 includes the method of any of aspects 1-2, further comprising determining a delta power value associated with the first transmit chain of the UE; and transmitting, to the BS, an indication of the delta power value via a radio resource control (RRC) communication.

Aspect 4 includes the method of any of aspects 1-3, wherein the delta power value is based on at least one of a default value; or a number of transmit chains associated with the UE.

Aspect 5 includes the method of any of aspects 1-4, wherein the transmit power level associated with the physical uplink channel is based on the delta power value.

Aspect 6 includes the method of any of aspects 1-5, wherein the transmitting the communication via the physical uplink channel comprises transmitting the communication in a first frequency range at the maximum transmit power level associated with the first transmit chain; and further comprising transmitting, to the BS, a second communication via a second transmit chain of the UE in a second frequency range at a maximum transmit power level associated with the second transmit chain, wherein the second frequency range is different from the first frequency range.

Aspect 7 includes the method of any of aspects 1-6, wherein the indicator indicating the transmit power level associated with the physical uplink channel is associated with a slot.

Aspect 8 includes the method of any of aspects 1-7, wherein the transmitting the indicator indicating the maximum transmit power level associated with the first transmit chain of the UE comprises transmitting the indicator via a radio resource control (RRC) communication.

Aspect 9 includes a method of wireless communication performed by a base station (BS), the method comprising receiving, from a user equipment (UE), an indicator indicating a maximum transmit power level associated with a first transmit chain of the UE; transmitting, to the UE, an indicator indicating a transmit power level associated with a physical uplink channel; and receiving, from the UE, a communication via the physical uplink channel at a lesser of the maximum transmit power level associated with the first transmit chain of the UE; or the indicated transmit power level associated with the physical uplink channel.

Aspect 10 includes the method of aspect 9, further comprising receiving, from the UE, an indicator indicating the UE supports uplink transmit (UL TX) switching; and wherein the receiving the indicator indicating the maximum transmit power level associated with the first transmit chain of the UE comprises receiving the indicator based on the UE support for UL TX switching.

Aspect 11 includes the method of any of aspects 9-10, further comprising receiving, from the UE, an indicator indicating a delta power value, wherein the transmitting the indicator indicating the transmit power level associated with the physical uplink channel comprises transmitting the indicator based on the delta power value.

Aspect 12 includes the method of any of aspects 9-11, wherein the receiving the indicator indicating the delta power value comprises receiving the indicator indicating the delta power value via a radio resource control (RRC) communication.

Aspect 13 includes the method of any of aspects 9-12, wherein the delta power value is based on at least one of a default value or a number of transmit chains associated with the UE.

Aspect 14 includes the method of any of aspects 9-13, wherein the receiving the communication via the physical uplink channel comprises receiving the communication in a first frequency range at the maximum transmit power level associated with the first transmit chain; and further comprising receiving, from the UE, a second communication via a second transmit chain of the UE in a second frequency range at a maximum transmit power level associated with the second transmit chain, wherein the second frequency range is different from the first frequency range.

Aspect 15 includes the method of any of aspects 9-14, wherein the indicator indicating the transmit power level associated with the physical uplink channel is associated with a slot.

Aspect 16 includes the method of any of aspects 9-15, wherein the receiving the indicator indicating the maximum transmit power level associated with the first transmit chain of the UE comprises receiving the indicator via a radio resource control (RRC) communication.

Aspect 17 includes a non-transitory computer-readable medium storing one or more instructions for wireless communication, the one or more instructions comprising one or more instructions that, when executed by one or more processors of a user equipment (UE), cause the one or more processors to perform any one of aspects 1-8.

Aspect 18 includes a non-transitory computer-readable medium storing one or more instructions for wireless communication, the one or more instructions comprising one or more instructions that, when executed by one or more processors of a base station (BS), cause the one or more processors to perform any one of aspects 9-16.

Aspect 18 includes a user equipment (UE) comprising one or more means to perform any one or more of aspects 1-8.

Aspect 19 includes a base station (BS) comprising one or more means to perform any one or more of aspects 9-16.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
transmitting, to a base station (BS), an indicator indicating a maximum transmit power level associated with a first transmit chain of the UE;
receiving, from the BS, an indicator indicating a transmit power level associated with a physical uplink channel; and
transmitting, to the BS, a communication via the physical uplink channel at a lesser of:
the maximum transmit power level associated with the first transmit chain of the UE; or
the indicated transmit power level associated with the physical uplink channel.

2. The method of claim 1, further comprising:
transmitting, to the BS, an indicator indicating the UE supports uplink transmit (UL TX) switching; and
wherein the transmitting the indicator indicating the maximum transmit power level associated with the first transmit chain of the UE comprises transmitting the indicator based on the UE support for UL TX switching.

3. The method of claim 1, further comprising:
determining a delta power value associated with the first transmit chain of the UE; and
transmitting, to the BS, an indication of the delta power value via a radio resource control (RRC) communication.

4. The method of claim 3, wherein the delta power value is based on at least one of:
a default value; or
a number of transmit chains associated with the UE.

5. The method of claim 3, wherein the transmit power level associated with the physical uplink channel is based on the delta power value.

6. The method of claim 1, wherein the transmitting the communication via the physical uplink channel comprises transmitting the communication in a first frequency range at the maximum transmit power level associated with the first transmit chain; and
further comprising:
transmitting, to the BS, a second communication via a second transmit chain of the UE in a second frequency range at a maximum transmit power level associated with the second transmit chain, wherein the second frequency range is different from the first frequency range.

7. The method of claim 1, wherein the indicator indicating the transmit power level associated with the physical uplink channel is associated with a slot.

8. The method of claim 1, wherein the transmitting the indicator indicating the maximum transmit power level associated with the first transmit chain of the UE comprises transmitting the indicator via a radio resource control (RRC) communication.

9. A method of wireless communication performed by a base station (BS), the method comprising:
receiving, from a user equipment (UE), an indicator indicating a maximum transmit power level associated with a first transmit chain of the UE;
transmitting, to the UE, an indicator indicating a transmit power level associated with a physical uplink channel; and
receiving, from the UE, a communication via the physical uplink channel at a lesser of:
the maximum transmit power level associated with the first transmit chain of the UE; or
the indicated transmit power level associated with the physical uplink channel.

10. The method of claim 9, further comprising:
receiving, from the UE, an indicator indicating the UE supports uplink transmit (UL TX) switching; and
wherein the receiving the indicator indicating the maximum transmit power level associated with the first transmit chain of the UE comprises receiving the indicator based on the UE support for UL TX switching.

11. The method of claim 9, further comprising:
receiving, from the UE, an indicator indicating a delta power value, wherein the transmitting the indicator indicating the transmit power level associated with the physical uplink channel comprises transmitting the indicator based on the delta power value.

12. The method of claim 11, wherein the receiving the indicator indicating the delta power value comprises receiving the indicator indicating the delta power value via a radio resource control (RRC) communication.

13. The method of claim 11, wherein the delta power value is based on at least one of:
a default value; or
a number of transmit chains associated with the UE.

14. The method of claim 9, wherein the receiving the communication via the physical uplink channel comprises receiving the communication in a first frequency range at the maximum transmit power level associated with the first transmit chain; and
further comprising:
receiving, from the UE, a second communication via a second transmit chain of the UE in a second frequency range at a maximum transmit power level associated with the second transmit chain, wherein the second frequency range is different from the first frequency range.

15. The method of claim 9, wherein the indicator indicating the transmit power level associated with the physical uplink channel is associated with a slot.

16. The method of claim 9, wherein the receiving the indicator indicating the maximum transmit power level associated with the first transmit chain of the UE comprises receiving the indicator via a radio resource control (RRC) communication.

17. A user equipment (UE) comprising:
a memory;
a transceiver; and
at least one processor coupled to the memory and the transceiver, wherein the UE is configured to:
transmit, to a base station (BS), an indicator indicating a maximum transmit power level associated with a first transmit chain of the UE;
receive, from the BS, an indicator indicating a transmit power level associated with a physical uplink channel; and
transmit, to the BS, a communication via the physical uplink channel at a lesser of:
the maximum transmit power level associated with the first transmit chain of the UE; or
the indicated transmit power level associated with the physical uplink channel.

18. The UE of claim 17, wherein the UE is further configured to:
transmit, to the BS, an indicator indicating the UE supports uplink transmit (UL TX) switching; and
transmit the indicator indicating the maximum transmit power level associated with the first transmit chain based on the UE support for UL TX switching.

19. The UE of claim 17, wherein the UE is further configured to:
determine a delta power value associated with the first transmit chain of the UE; and
transmit, to the BS, an indication of the delta power value via a radio resource control (RRC) communication.

20. The UE of claim 19, wherein the delta power value is based on at least one of:
a default value; or
a number of transmit chains associated with the UE.

21. The UE of claim 19, wherein the transmit power level associated with the physical uplink channel is based on the delta power value.

22. The UE of claim 17, wherein the UE is further configured to:
transmit, to the BS, the communication in a first frequency range at the maximum transmit power level associated with the first transmit chain; and
transmit, to the BS, a second communication via a second transmit chain of the UE in a second frequency range at a maximum transmit power level associated with the second transmit chain, wherein the second frequency range is different from the first frequency range.

23. The UE of claim 17, wherein the indicator indicating the transmit power level associated with the physical uplink channel is associated with a slot.

24. The UE of claim 17, wherein the UE is further configured to:
transmit the indicator indicating the maximum transmit power level associated with the first transmit chain of the UE via a radio resource control (RRC) communication.

25. A base station (BS) comprising:
a memory;
a transceiver; and
at least one processor coupled to the memory and the transceiver, wherein the BS is configured to:
receive, from a user equipment (UE), an indicator indicating a maximum transmit power level associated with a first transmit chain of the UE;
transmit, to the UE, an indicator indicating a transmit power level associated with a physical uplink channel; and
receive, from the UE, a communication via the physical uplink channel at a lesser of:
the maximum transmit power level associated with the first transmit chain of the UE; or
the indicated transmit power level associated with the physical uplink channel.

26. The BS of claim 25, wherein the BS is further configured to:
receive, from the UE, an indicator indicating the UE supports uplink transmit (UL TX) switching; and
receive the indicator indicating the maximum transmit power level associated with the first transmit chain of the UE based on the UE support for UL TX switching.

27. The BS of claim 25, wherein the BS is further configured to:
receive, from the UE, an indicator indicating a delta power value via a radio resource control (RRC) communication; and
transmit the indicator indicating the transmit power level associated with the physical uplink channel based on the delta power value.

28. The BS of claim 27, wherein the delta power value is based on at least one of:
a default value; or
a number of transmit chains associated with the UE.

29. The BS of claim 25, wherein the BS is further configured to:
receive, from the UE, the communication in a first frequency range at the maximum transmit power level associated with the first transmit chain; and
receive, from the UE, a second communication via a second transmit chain of the UE in a second frequency range at a maximum transmit power level associated with the second transmit chain, wherein the second frequency range is different from the first frequency range.

30. The BS of claim 25, wherein the indicator indicating the transmit power level associated with the physical uplink channel is associated with a slot.
